(19) United States
(12) Patent Application Publication
(10) Pub. No.: US 2008/0027881 A1
(43) Pub. Date: Jan. 31, 2008

(54) Market trader training tool

(76) Inventor: Stephan Kurt Jan Bisse, Oxford (GB)

Correspondence Address: HARNESS, DICKEY & PIERCE, P.L.C., P.O. BOX 828, BLOOMFIELD HILLS, MI, 48303, US

(21) Appl. No.: 11/483,417

(22) Filed: Jul. 7, 2006

(51) Int. Cl. G06Q 40/00

(52) U.S. Cl. 705/36 R

(57) ABSTRACT

In a market trader training method according to the invention, data representing market price as a function of time is retrieved and a visual representation of a portion of the market price data as a function of time is displayed to a user. The user inputs a response based on his prediction of the subsequent movement of the market price. An indication of whether the user's input response was in accordance with the actual subsequent movement of the market price known from the retrieved data is then displayed.

### BACKGROUND OF THE INVENTION

The invention relates to a tool, such as a method or system, for training a trader to trade in markets, such as financial and commodity markets.

Financial trading is one of the most difficult skills to learn because the financial and commodity markets are very efficient and therefore very nearly random. Conventionally the trader has to learn the behaviour of the market or markets through experience, which can take a very long time to build up, because the trader can only learn in real time. In other words, the problem is that too much time elapses between making a decision and getting the feedback on whether the decision was right or wrong. For novice traders this process of learning the markets and gaining an intuition for their behaviour can take years.

Teaching systems over the internet are known, as are trading simulations whereby trading is simulated using past price data. However these conventional systems are inefficient because they rely on the mere presentation of information using text, audio or video comprising the entire course, or do not give adequate responsive feedback and reinforcement.

### SUMMARY OF THE INVENTION

One aspect of the present invention provides a market trader training method comprising: retrieving data representing market price as a function of time; displaying to a user a visual representation of a portion of the market price data as a function of time; receiving an input response from the user based on the user's prediction of the subsequent movement of the market price; and giving an indication to the user of whether the user's input response was in accordance with the actual subsequent movement of the market price known from the retrieved data.

Another aspect of the invention provides a market trader training apparatus comprising: a retrieving unit for retrieving data representing market price as a function of time; a display for displaying to a user a visual representation of a portion of the market price data as a function of time; an input device for the user to input a response based on his prediction of the subsequent movement of the market price; and a processor for comparing the input response with the actual subsequent movement of the market price known from the retrieved data, and giving an indication to the user of whether the user's input response was in accordance with the actual subsequent movement of the market price known from the retrieved data.

A further aspect of the invention provides a program for causing a computer to carry out a procedure comprising the steps of: retrieving data representing market price as a function of time; displaying to a user a visual representation of a portion of the market price data as a function of time; receiving an input response from the user based on the user's prediction of the subsequent movement of the market price; and giving an indication to the user of whether the user's input response was in accordance with the actual subsequent movement of the market price known from the retrieved data.

Thus the invention concerns an educational system that allows the trader (the user of the system, who purchases the courses) to replay the history of multiple markets and make trading decisions, in order for the trader to quickly build an intuition of how a market or set of markets behaves. The trader's performance can be monitored and displayed.

Embodiments of the invention assists the trader to build up a thorough knowledge and intuition about how the chosen markets behave, how to manage risk, spot trends and place stop orders. By giving the feedback on each trading decision rapidly, and using prolonged practical exercises with repetition of actions, the invention can assist the sub-conscious learning process by the cognitive psychological principle known as operant conditioning.

### BRIEF DESCRIPTION OF THE DRAWINGS

FIG. 1a is a schematic overview of a system embodying the invention comprising a server, a trader's own computer and payment provider connected via the internet;

FIG. 1b is a sitemap of the training website on the server;

FIG. 2a shows the homepage for the logged-in user;

FIG. 2b is a screen shot showing the Main Activity Screen for Module 1;

FIG. 3 shows the chart area of FIG. 2b;

FIG. 4 shows the Market Information Box of FIG. 2b;

FIG. 5 shows the Time Limit Box of FIG. 2b;

FIG. 6 shows an example of the Instant Feedback Box of Module 1;

FIG. 7a shows the Voting Box for Module 1 ready to receive an input vote response;

FIG. 7b shows the Voting Box for Module 1 after voting;

FIG. 8 shows the Statistics Control Box of FIG. 2b;

FIG. 9 shows the Results Graph Box of FIG. 2b;

FIG. 10 shows the Results Text Box of FIG. 2b;

FIG. 11 is a screen shot showing the Main Activity Screen for Module 2;

FIG. 12 is the Market Price Chart in the chart area of FIG. 11;

FIG. 13 shows the Market Information Box of FIG. 11;

FIG. 14 shows the Voting Box of FIG. 11;

FIG. 15 is an example of the Results Graph Box of Module 2 showing a tick count graph;

FIG. 16 is a screen shot showing the Main Activity Screen for Module 3;

FIG. 17 is the Market Price Chart area of FIG. 16;

FIG. 18 shows the Main Activity Screen for Module 4;

FIG. 19 shows the Position Size Box of FIG. 18;

FIG. 20 is a screen shot showing the Main Activity Screen for Module 5;

FIG. 21 shows the Market Price Chart area of FIG. 20;

FIG. 22 shows the status screen that gives a progress report for a module;

FIG. 23 shows a module summary screen with lesson debrief text;

FIG. 24 shows a module summary screen with lesson performance comparison graph;

FIG. 25 shows a module summary screen with performance improvement graph for Module 1;

FIG. 26 shows a module summary screen with tick count comparison graph for lessons of Module 2;

FIG. 27 shows a module summary screen with historical performance graphs for Module 2; and

FIG. 28 shows a module summary screen with graph of hit rate for comparison between a lesson of Module 3 and a lesson of Module 2.

### TERMINOLOGY

Trading uses some specialist terms. Some of the terms which are relevant to the following description are listed here to assist understanding. This list of terms is neither exhaustive nor limiting. Other meanings and usages of these terms, as well as further specialist terms, will be understood by the person skilled in this art.
Security Something being traded in a market. For example, when considering the gold market then the security is gold.
Bullish A view that a market price will go up.
Bearish A view that a market price will go down.
Tick The smallest unit by which a market can move. For example, in the EURUSD currency pair, a price change from 1.1003 to 1.1004 is a movement of one tick.
Bid The price at which a trader can sell a security.
Offer The price at which a trader can buy a security. Also known as the Ask.
Spread The difference between the bid and the offer prices. The broker makes some of his money this way.
Broker The broker enables the trader to place his trades, by operating the trading platform.
Trading platform Computer software which shows market prices and is used by the trader to place trades.
Commission A cost incurred for every transaction made by the trader. The broker makes money by charging this fee.
Sell short It is possible to sell a security before buying it; the trader buys back later to cover what he has sold. This selling before buying is known as going short.
P&L Short for Profit & Loss, the real amount of money that would be made or lost if trading for real in the financial markets.
Position If the trader has initially bought or sold a security, but has not yet carried out the opposite transaction in order to get back to holding exactly zero lots of the security, then they are said to have a position in the market.
Open a trade To initially buy or sell a security is to open a trade.
Close a trade After opening a trade, to then sell or buy back the security, moving back to holding exactly zero lots of the security, is to close the trade.
Hit rate The percentage of the time that a trader accurately predicts the next movement in the market, upwards or downwards.
Slippage Not all orders are filled (ie the transaction is actually carried out) at the expected price, since the market may be moving quickly or the last quoted price is no longer available. The difference between the price a trader expects to trade at and the price at which his order actually gets filled is called slippage.

### DESCRIPTION OF THE PREFERRED EMBODIMENTS

Embodiments of the invention will now be described by way of example only, with reference to the accompanying drawings.

Technical Overview

The system runs across the internet, and is hosted on web servers. The trader accesses the information via a web browser. Use is made of text, images, video and sound. No specific client software needs to be downloaded by the trader (other than the web browser, Flash plugin, etc).

In the preferred embodiment, the course runs purely online: printed course material (other than possibly invoices etc) and CD-ROMs, etc are not sent out to users The base hardware, underlying software and configuration are industry-standard:
Server operating system: Linux.
Database: MySQL.
Server programming language: Ruby on Rails.

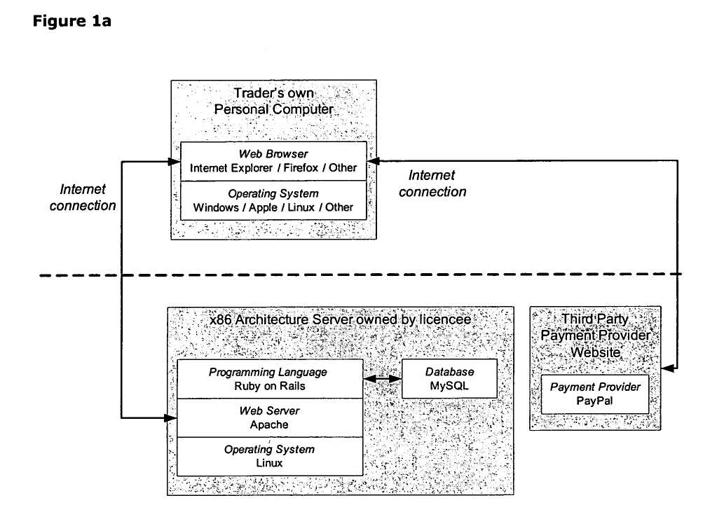

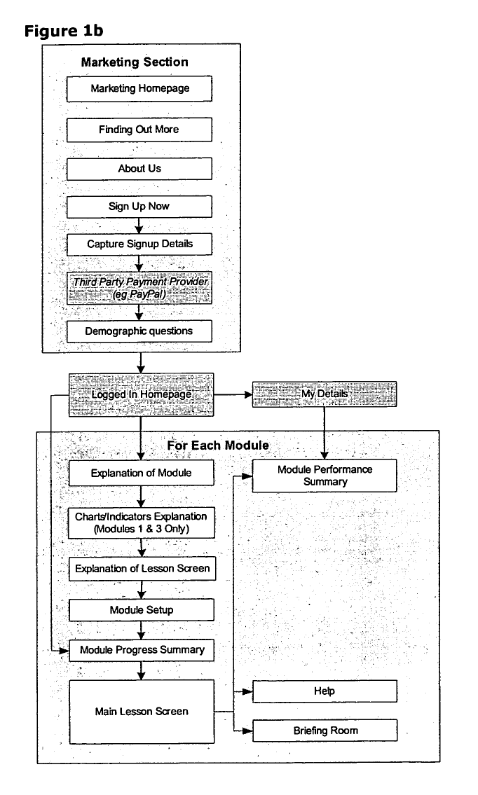

FIG. 1a shows a technical overview of the system setup, and FIG. 1b is a site map of the website embodying the invention. The subsequent Figures are screen shots, or portions of the screen images, shown on the display of the user's (trader's) own personal computing device.

All payments, which are made via credit or debit card, are handled by a third party payment provider. The system does not process transactions directly for reasons of security. The third party payment provider is any suitable service, such as PayPal.

Sales Process and Module Bundles

The training course of this exemplary embodiment is broken into five modules, each focusing on a different element of trading. Each module is further divided into five lessons. Additional modules can be defined as required.

This document will later describe each module in detail.

Modules can be purchased separately or in bundles.

Modules are bundled according to the skills which they aim to develop, from the basics through to more advanced techniques.

| Bundle | Modules Included |
|---|---|
| Basic Intuition | 1, 2, 3 |
| Advanced Intuition | 4, 5 |

Features Relevant to all Modules

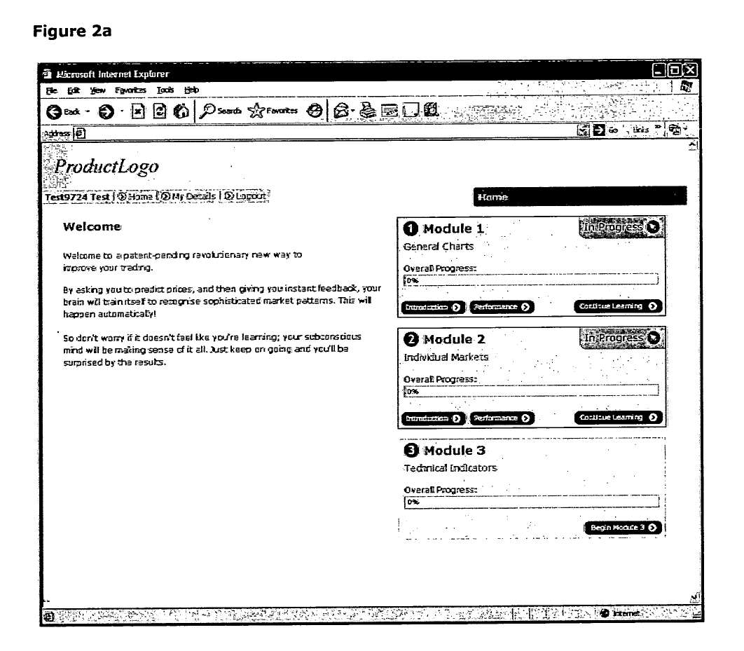

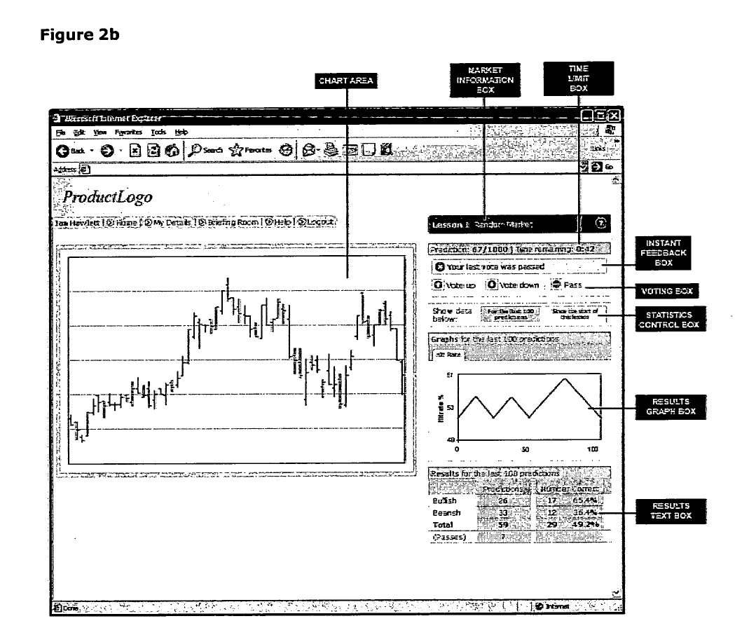

FIG. 2a shows the Logged-In Homepage. This is the first screen that the trader (user) sees when he logs into the system. It shows his progress in each module, and lets him begin or continue through his chosen modules.

Since each lesson and hence each module takes several hours to complete, the trader's progress is saved after every decision that the trader makes. Thus if the internet connection is lost, or the trader wishes to take a break, he can continue from where he left off.

Every market-based action that the trader takes, such as voting on whether a market will go up or down, is saved to the database. Minor actions such as a trader looking at a help file are not recorded.

Data and Charting

The system in this particular embodiment uses only end-of-day data, meaning that for each day we have the following four pieces of price information:

Open: The market price at the beginning of the trading session.

Close: The market price at the end of the trading session.

High: The highest market price reached during the trading session.

Low: The lowest market price reached during the trading session.

The system uses standard financial bar charts which are common to all financial charting packages (see FIG. 3 for an example). Bars where the close is higher than the open are green. Bars where the close is lower than the open are red. Each bar, as shown for example in FIG. 3, consists of a vertical line, the top end of which indicates the High and the bottom end of which indicates the Low. The horizontal line on the left-hand side of the bar indicates the Open and the horizontal line on the right-hand side of the bar indicates the Close.

Alternative embodiments of the invention could make use of intra-day data, ie data for every 5 minute period that the market is open, rather than end-of-day data.

Market Categories and Markets

Although each module may display different data, the master list of market categories and markets remains the same. 10 years of daily data is kept for each market (where this is available, for example the Euro currency only began trading in 1999). Daily data means that for each trading day one open, close, high and low price is stored.

The categories and markets in the present embodiment are as follows, but may be changed or may be expanded upon. Futures are divided into sub-categories.

Foreign Exchange (also known as Forex or FX)

| Symbol | Description |
|---|---|
| EURUSD | Euro vs US Dollar |
| GBPUSD | British Pound vs US Dollar |
| USDJPY | US Dollar vs Japanese Yen |
| EURGBP | Euro vs British Pound |
| EURJPY | Euro vs Japanese Yen |

US Stocks

| Symbol | Description |
|---|---|
| MSFT | Microsoft |
| IBM | International Business Machines |
| GE | General Electric |
| IP | International Paper |
| JPM | J P Morgan Chase |
| GM | General Motors |
| WMT | Wal-mart |
| XOM | Exxon |
| YHOO | Yahoo |
| TXN | Texas Instruments |
| DIS | Disney |

UK Stocks

| Symbol | Description |
|---|---|
| VOD-L | Vodafone |
| BTA-L | British Telecom |
| BG-L | British gas |
| MAB-L | Mitchells and Butlers |
| ITV-L | ITV |
| YEU-L | YEU |
| BOOT-L | Boots Group |
| IMT-L | Imperial Tobacco |
| SAB-L | Sabmiller |

Futures

Energy

Crude oil

Heating oil

Natural gas

Bonds

US Dollar 10 year notes

Bunds

Gilts

Currencies

British Pound

Japanese Yen

Swiss Franc

Stocks

S&P 500

DAX

FTSE 100

Soft Commodities

Coffee

Cotton

Sugar

Grains

Soybeans

Wheat

Cotton

Metals

Gold

Silver

Short Term Interest Rates (STIR)

EuroDollar

Euribor

Short Sterling

Module 1: General Charts

Background

Since a price chart represents the balance of supply and demand over time, at the most basic level the charts for any market across any timeframe exhibit similar behaviour and patterns. For example, a chart showing the price of a stock and a chart showing the price of a currency pair will look similar. Markets are also fractal in nature, meaning that without labelling the axis of the charts it is difficult to tell whether the chart covers a period of for example one day or one month.

Aims of this Module

This module aims to develop intuition for price charts at the most general and basic level. We explicitly do not give tuition on what to look for on the charts, such as particular patterns. Rather, the aim of the software is that the trader's brain will train itself by virtue of the principles of operant conditioning.

Setup Before Beginning this Module

Before beginning the module, the trader is asked to select a category of markets to focus on. The trader must then select 5 specific markets in this category that he wishes to focus on. For each of these categories, the system recommends which specific markets the trader should concentrate on if he has no preference. These recommendations are based upon (but are not strictly) the markets which have the highest trading volumes.

Charts Shown

Each chart shown in Module 1 is of a random market drawn from the trader's selected market category. It covers a random time period, and the charts are not sequential (ie they do not advance one day at a time).

Main Activity Screen and Behaviour

FIG. 2b shows the Main Activity Screen that is presented to the trader when he starts Module 1. The sections of this screen are further broken down in the following figures.

FIG. 3 shows the Chart Area for Module 1. Each price bar covers one day of data. Approximately 70 days of data are shown on the chart (70 price bars). For module 1, the chart is not labelled. It has no time or price axes labels, and there are no technical indicators or other features on the chart. Each lesson shows 1,000 charts. The bars are coloured either green or red according to existing standard conventions for the drawing of bar charts.

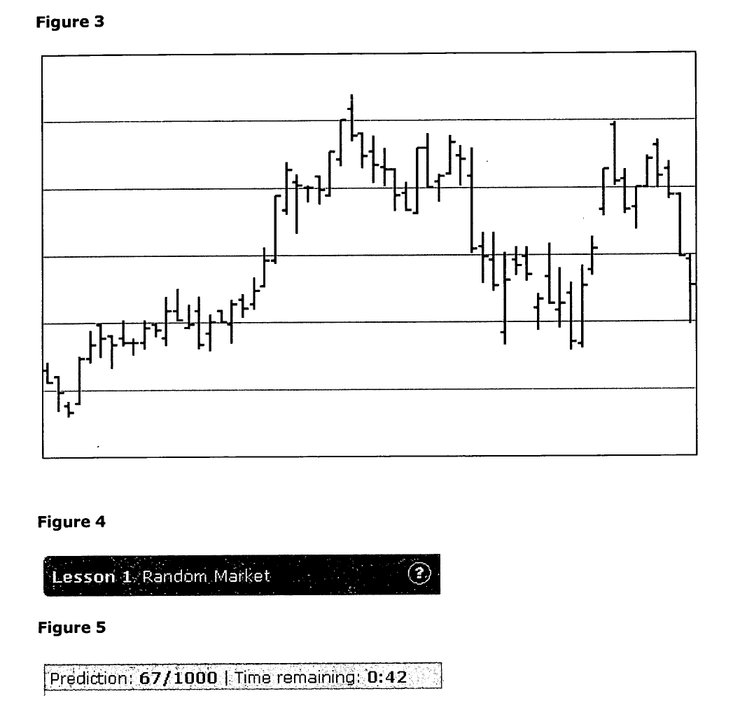

FIG. 4 shows the Market Information Box. In Module 1 it just indicates that random markets are being displayed.

FIG. 5 shows the Time Limit Box. This gives a time limit which counts down on the screen.

FIG. 6 shows the Instant Feedback Box for Module 1, which is how the instant feedback mechanism works. A crucial part of the learning process using this type of operant conditioning is the provision of instant feedback. This is given by placing the correct or incorrect result of the trader's vote prominently in the trader's field of vision. If the last prediction was correct then the Instant Feedback Box is green. If the last prediction was incorrect then the Instant Feedback Box is red. The feedback in this and other modules is given a rapidly as practical; i.e. so that it appears substantially instantaneous to the trader, and certainly in less than, say, one minute. Thus the system does not simulate trading in real time or even in scaled, speeded-up time, and there is no artificial delay between voting and receiving the feedback.

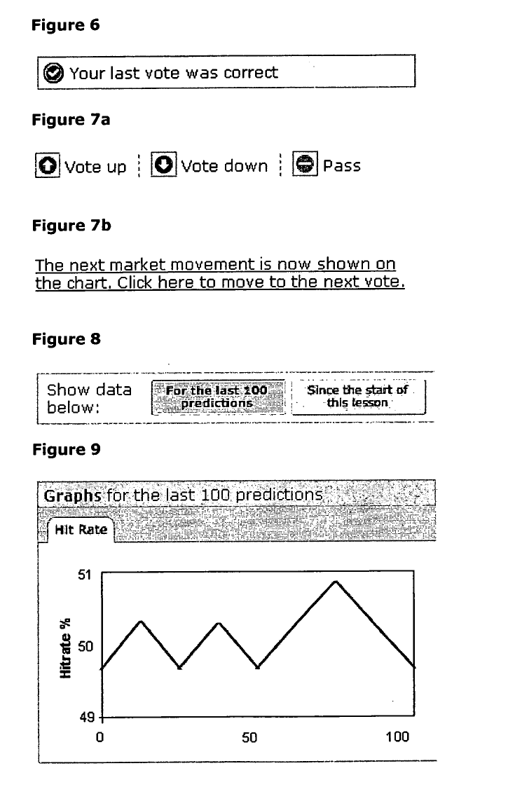

FIG. 7a shows the Voting Box for Module 1. It allows the trader to vote up, vote down or to pass. The trader votes “up” if he thinks that the close of the next price bar will be higher than the close of the price bar currently to the right-most of the chart. The trader votes “down” if he thinks the opposite will be the case. The trader votes “pass” if he is not sure which way the market will move. The trader inputs his response, i.e. vote, by clicking on the relevant button in the voting box, using, for example a computer mouse, in conjunction with pointer on the screen, as input device.

The trader gets a limited time in which to cast his vote. The time limit counts down on the screen. In lesson 1 this time limit is set to 2 minutes. The time limit decreases for lesson 2, decreases again for lesson 3, and similarly for lessons 4 and 5. If the trader runs out of time then he is not allowed to cast a vote, and the system acts as if he had chosen to vote “pass”.

After the trader has voted, the same chart is shown again, but is advanced by one day to show the actual outcome of the day on which the trader was voting. This is simply to provide feedback to reinforce the learning process. The Voting Box is then changed as shown in FIG. 7b to give instructions to the trader that the next market movement is being shown. After clicking, the next chart for voting is shown, which for this initial module is randomly drawn from the trader's selected market category and is not sequentially related in time to the chart that the trader has just voted on.

FIG. 8 shows the Statistics Control Box. This allows the user to choose whether to show on the screen statistics for the last 100 predictions or since the start of the lesson.

FIG. 9 shows the Results Graph Box for Module 1. For this module, it shows only one graph. In FIG. 9 is a graph showing the rolling hit-rate for the last 100 predictions. This is plotted as a line graph based on the Total Percentage Correct figure shown in the Results Text Box. The graph theoretically runs between 0% and 100%, but is scaled for ease of viewing. Optionally, because at the start of each lesson the trader will not have cast 100 votes, the chart may only begin to be drawn after 10 votes have been cast.

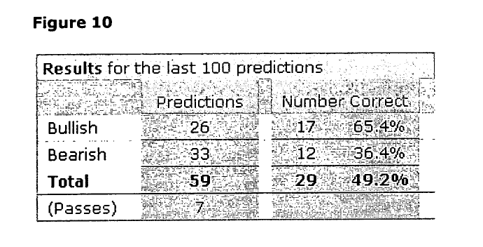

FIG. 10 shows the Results Text Box for Module 1. This shows the trader's results for the last 100 predictions. Charts that the trader passed on without voting are counted separately. It gives the total number of previous votes (up to 100), with the number and percentage of these votes that were correct. It then further breaks these down into results for bullish votes (where the trader said that the market would go up) and for bearish votes (where the trader said that the market would go down). These breakdown figures are given for information purposes only, since in times where most markets are rising it becomes easier to forecast bullish behaviour than bearish.

The Final 100 Charts

For this module, the final 100 charts shown at the end of lesson 5 will be the same as the first 100 charts shown at the start of lesson 1. By asking the trader to vote on these same charts twice, the system can check for overall improvement in the trader's forecasting ability during the course of the module. See the section in this document on module summaries for how this data is displayed.

Module 2: Individual Markets

Setup Before Beginning this Module

The setup for this module is the same as for Module 1, in that 5 specific markets are to be concentrated upon. If the trader has already done the setup for Module 1 then these same settings are retained for Module 2. The trader can change these 5 markets if he wants to.

The categories and markets are the same as those discussed previously.

Charts Shown

The system steps sequentially through each of the five markets in turn, showing 2,500 data points for each market (around 10 years of data), ending in the most recent market data available in the course database. Where this quantity of data is not available, such as for the Euro, as much data as possible will be displayed.

For example, in foreign exchange, the system could show the following:
GBP/USD chart beginning on 1 Jan. 1995
GBP/USD chart beginning on 2 Jan. 1995
Etc
GBP/USD chart beginning on 31 Dec. 2005
USD/JPY chart beginning on 1 Jan. 1995
USD/JPY chart beginning on 2 Jan. 1995
Etc
USD/JPY chart beginning on 31 Dec. 2005
Etc for remaining currency pairs.

Main Activity Screen and Behaviour

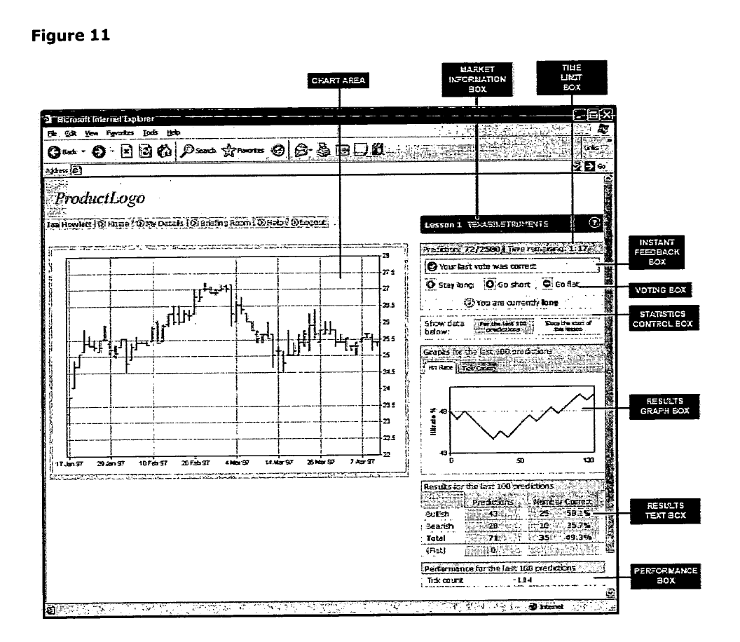

FIG. 11 shows the Main Activity Screen for Module 2. This module is very similar to Module 1.

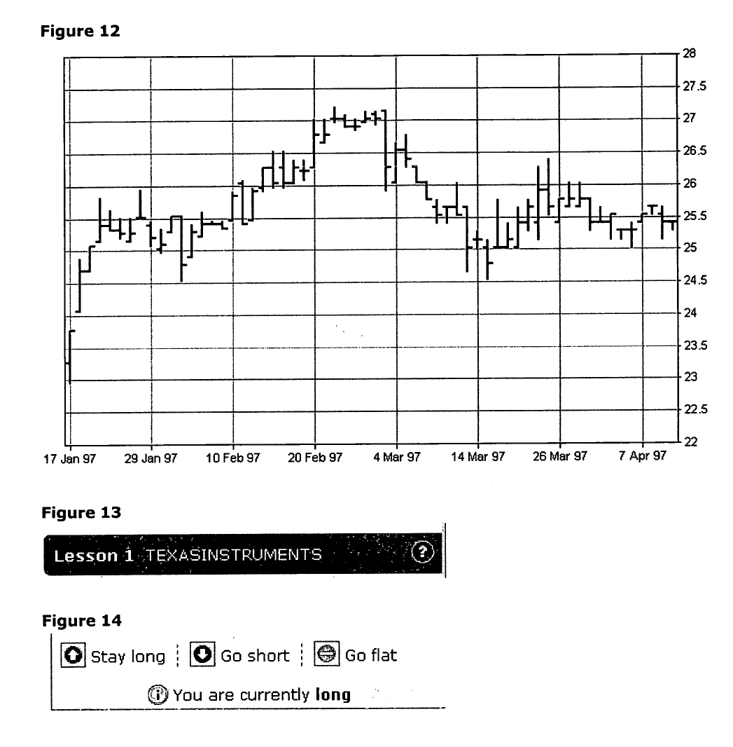

FIG. 12 shows the Market Price Chart for Module 2, which now has labels for both axes: time along the bottom and price up the side.

FIG. 13 shows the Market Information box for Module 2. This now contains the name of the market being traded.

FIG. 14 shows the Voting Box, which has changed from module 1. It now uses different terminology and asks the user to take one of three positions: long, meaning that they have bought; short, meaning that they have sold; and flat which means that they have a zero balance. It also shows their current position. The underlying logic here remains the same as in module 1, just the terminology has changed.

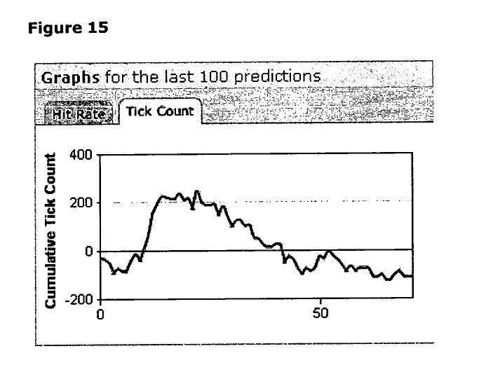

FIG. 15 again shows the Results Graph Box for Module 2, but this time with a tick count graph. Each vote up or down is given a tick score according to how the market moved. For example, if the trader predicted that the market would go up, and it actually went up by 5 ticks, the Tick Count would increase by 5. If the trader predicted that the market would go up, but it actually went down by 10 ticks, the Tick Count would go down by 10 ticks. It is possible for the Tick Count to be negative.

Two tick count numbers are shown: the tick count for the last 100 votes in this lesson, and also the cumulative tick count for this lesson as a whole. This is so that the trader can gain intuition of the form “I am making money overall, but currently I am going through a bad patch.” He can then develop intuition for when the market conditions are best for him to make money, for example he might well lose when the markets are choppy and trading sideways, but make money when the markets are more clearly trending.

The Final 100 Charts

Since the charts are shown sequentially, Module 2 does not repeat the first 100 charts at the end of the module.

Differences between Each Lesson

Each lesson in Module 2 takes the same format. Each of the 5 lessons covers one of the 5 markets. The time limit remains constant in Module 2 and does not decrease with each lesson.

Module 3: Introduction to Technical Indicators

Setup Before Beginning this Module

The setup for this module is the same as for Module 2, in that 5 specific markets are to be concentrated upon. If the trader has already done the setup for Module 2 then these same settings are retained for Module 3. The trader can change these 5 markets if he wants to, but is discouraged from doing so since a comparison of the trader's performance in Modules 2 and 3 is later given.

Background: Technical Indicators

Technical Indicators are additional calculations that can be shown on market price charts. Here, they take one of two forms: they can appear as extra data on the price chart itself alongside the bars, or they can appear in additional windows below the main price chart. This depends on how each indicator works and what kind of scale it uses.

The indicators are standard throughout the financial world and have their values calculated based on the values of the price bars.

Presentation of the Introduction to Technical Indicators

Technical Indicators require explanation and some guidance on interpretation, which are given as part of the course. This is standard information throughout the financial trading world. The trader is provided with this information using text, images and video presentations with voiceovers which stream across the internet in the format of Macromedia Flash (and possibly additional formats).

This information is given on a screen called the Briefing Room. The trader can come back to this screen at any time.

A Quick Reference Card is also given, saved in Adobe PDF format, which the trader can have open on his screen or preferably print out for use during this module.

Module 3 uses the following technical indicators, chosen because they are so common, and the trader cannot change these:
Fast stochastic
Slow stochastic
MACD (Moving Average Convergence Divergence)
RSI (Relative Strength Index)
Moving Average

Charts Shown

The charts shown to the trader in Module 3 are the exact same charts as those shown in Module 2, as long as the trader has not changed his preferences for which markets he wishes to focus on. This allows a comparison of the trader's performance in Modules 2 and 3.

Main Activity Screen and Behaviour

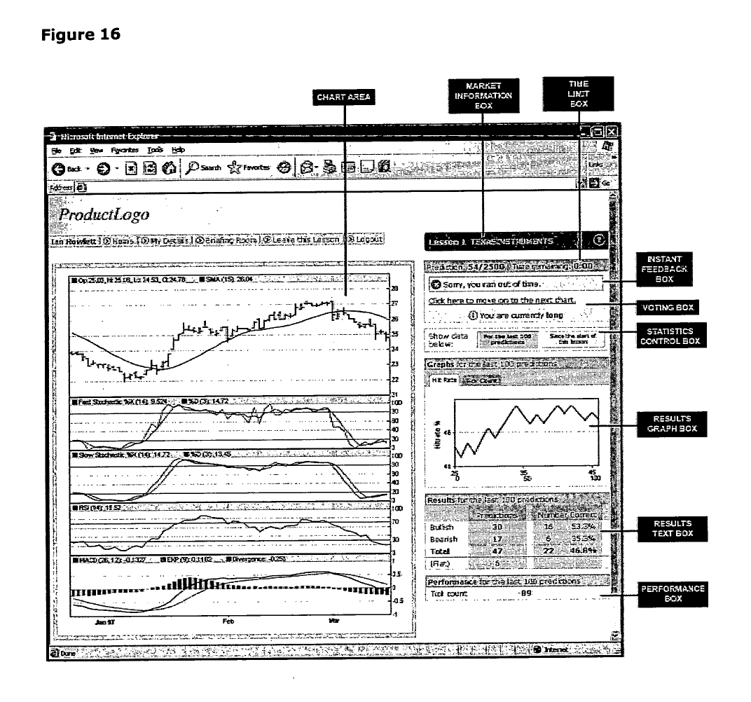

FIG. 16 shows the Main Activity Screen layout for Module 3. Only the Market Price Chart area is different from Module 2, the other boxes remain the same.

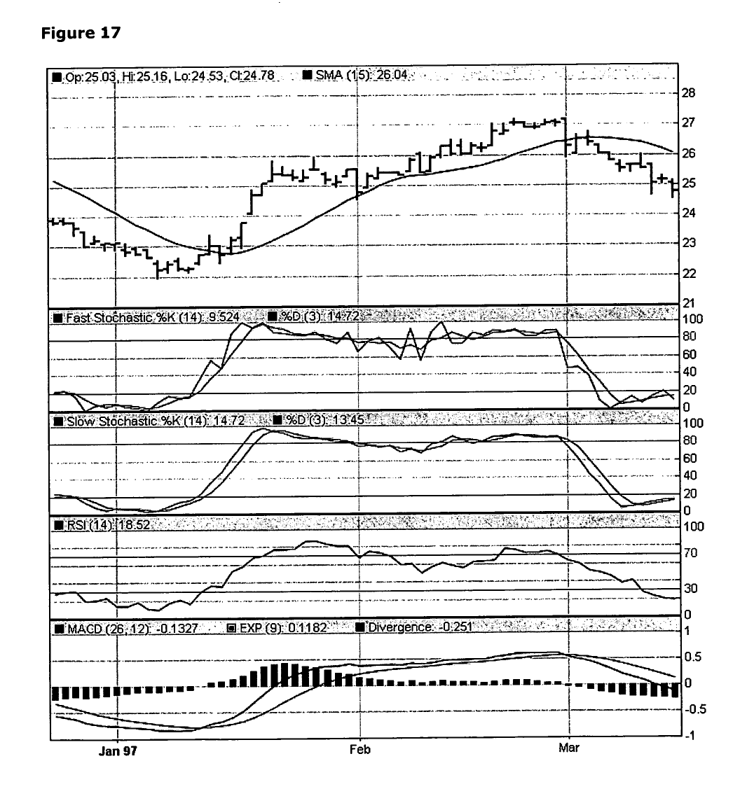

FIG. 17 shows the Market Price Chart area for Module 3, which now contains technical indicators along with labelling of the chart axes for each area of the chart.

Differences between Each Lesson

Each lesson takes the same format. Each of the 5 lessons covers one of the 5 markets. The time limit remains constant in this module and does not decrease with each lesson.

Module 4: Position Sizing and Risk Managment

Setup before Beginning this Module

The setup for this module is the same as for Module 3, in that 5 specific markets are to be concentrated upon. If the trader has already done the setup for Module 3 then these same settings are retained for Module 4. The trader can change these 5 markets if he wants to, but is discouraged from doing so since a comparison of the trader's performance in Modules 2, 3 and 4 is later given.

In addition, the transaction costs for each market must be set. The system uses one of two single overall costs per transaction: one cost for normal trades, or a higher cost for trades which get carried out as a result of a stop order (due to increased slippage). The system recommends these transaction costs for each market, but the user can modify these to be consistent with his own real-life trading platform.

The trader is also asked to specify the amount of capital that he will allocate to his trading (eg he may wish to open his trading account with £10,000). This amount should be in line with the trader's real-world trading capital that he has available.

Background: Position Sizing and Risk Management

When moving from the more simple modules to a realistic Profit & Loss account, extra considerations must be addressed by the trader. These include:
The amount of money to be placed on each trade
When to exit the trade, possibly automatically if the price reaches a certain point using a stop-loss order.
Transaction costs, eg a flat fee of £10 per trade for trading stocks.
The cost of the spread (the difference between the price at which buying and selling take place).
The psychological effects of trading for real money as opposed to “paper” money.

Presentation of Key Concepts

The presentation of the key concepts of position sizing and risk management is via text, audio and video. This is given at the start of the module, and the trader can return to it at any time via the Briefing Room.

Charts Shown

The charts shown to the trader in Module 4 are the exact same charts as those shown in Module 3, with technical indicators, as long as the trader has not changed his preferences for which markets he wishes to focus on. This allows a comparison of the trader's performance in Modules 2, 3 and 4.

Main Activity Screen and Behaviour

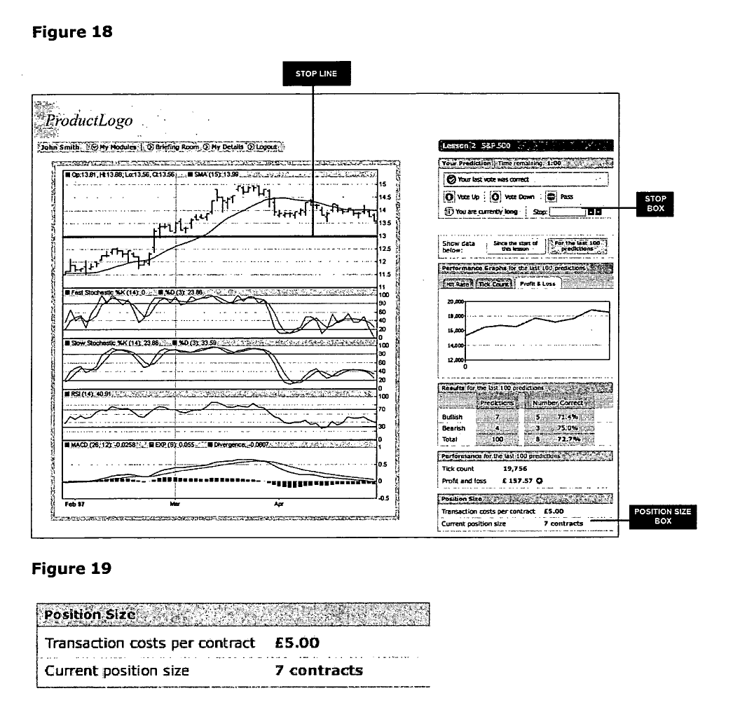

FIG. 18 shows the main screen for Module 4. This is the same as for Module 3, and includes the technical indicators, but for this module it also includes an additional graph tab in the Results Graph Box for the Profit & Loss account, facilities for placing a stop order, and a Position Size Box to record the size of positions as they are calculated. All transactions are taken at the opening price of the next bar, except when a stop order would have been activated.

Position Size

Helping the trader to determine his position size (ie how much money he will place on each trade) is important. The system uses a standard, if quite sophisticated, method of determining the position size. This is calculated by using a formula which incorporates the amount of capital, the standard deviation of daily change in the market over the last 100 periods, and the money value of the moves in the market).

FIG. 19 shows how the current position size is displayed to the trader after being automatically calculated. The position size varies over time.

Placing the Stop Order

When the mouse pointer is moved over the price chart a horizontal Stop Line will appear, representing the price at which the stop order is to be placed. When the trader clicks the price chart the line is stuck to the chart at this point. The floating line will continue to appear so that the user can click a second time to re-set the stop order.

When the trader clicks on the chart, the price of the stop order is put into the Stop Box text box by the voting panel. The price can then be further adjusted by typing into the text box if required, or by clicking the small arrows adjacent to the text box.

The price for the stop order remains the same from one vote to the next until either it is changed by the trader or the stop order is met by the next price bar.

Differences Between Each Lesson

Each lesson takes the same format. Each of the 5 lessons covers one of the 5 markets. The time limit remains constant in this module and does not decrease with each lesson.

Lesson Summary and Module Summary

The lesson summary and module summary are similar to those given for Module 3, with the addition of an extra chart for a lesson comparison of the Profit and Loss figures.

Module 5: Inter-Market Relationships

Setup Before Beginning this Module

The setup for this module is the same as for Modules 2, 3 and 4, in that 5 specific markets are to be concentrated upon. If the trader has already done the setup for an earlier module then these same settings are retained for this module. The trader can change these 5 markets if he wants to, but is discouraged from doing so since a comparison of the trader's performance in Modules 2, 3 and 4 is later given.

Background: Inter-Market Relationships

This module deals with how price movements in other markets affect the price being predicted. Markets are to some extent correlated.

Presentation of Inter-Market Relationships

The choice of markets to compare with the trader's chosen markets will be given by the system. Other than this, no explicit instruction will be given as to which markets are correlated with which, or how strongly. The trader will come to recognise this as the module progresses.

Charts Shown

The charts shown to the trader in this module are the exact same charts with the same data as those shown in Module 4, as long as the trader has not changed his preferences for which markets he wishes to focus on. Technical indicators are not shown. A full Profit & Loss count is not shown.

Main Activity Screen and Behaviour

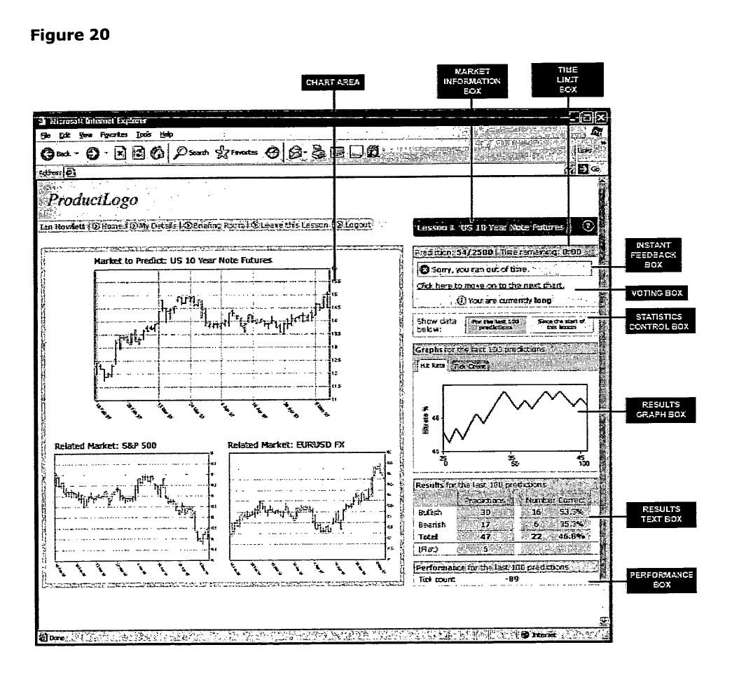

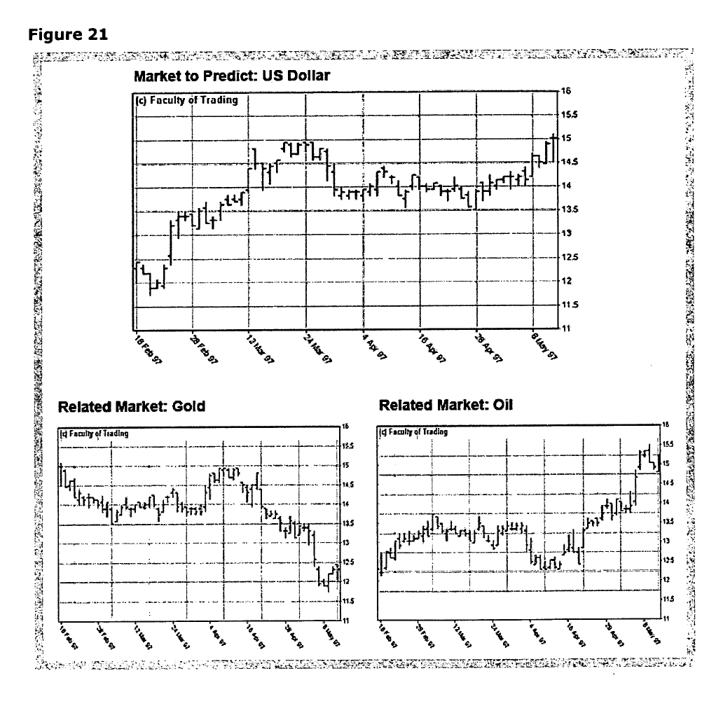

FIG. 20 shows the Main Activity Screen layout for this module. Only the Market Price Chart area is different from Module 2, the other boxes remain the same. There is no profit and loss record kept in this module.

FIG. 21 shows the Market Price Chart area for this module. The trader is asked to vote only on one of the markets, namely the market shown at the top of the screen. The remaining charts show the markets that the system recommends as being inter-related with the chosen markets. Between 1 and 3 additional markets will be shown.

The inter-market relationships may be either within the trader's chosen category or across categories, depending on what is sensible. Some examples of related markets are as follows:

Market: US 10 year notes futures.

Inter-related markets: S&P 500, EURUSD STIR, EURUSD FX.

Market: Eurobund.

Inter-related markets: Euribor, EURUSD.

Market: FTSE.

Inter-related markets: Short Sterling, GBPUSD.

Differences between each lesson

Each lesson in this module takes the same format. Each of the 5 lessons covers one of the 5 markets. The time limit remains constant in this module and does not decrease with each lesson.

Module and Lesson Summaries

Continuing a lesson

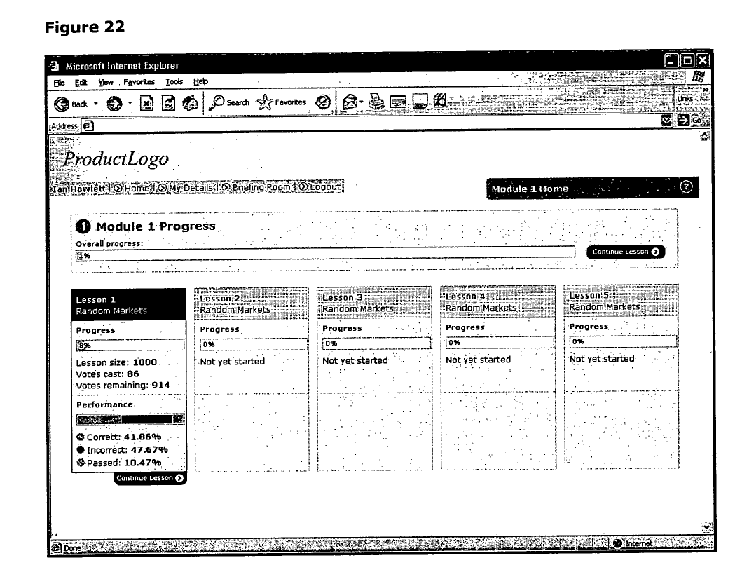

The trader can take a break from a lesson and come back to it at any time. FIG. 22 shows the status screen that gives a progress report for a module.

Module 1 Summaries

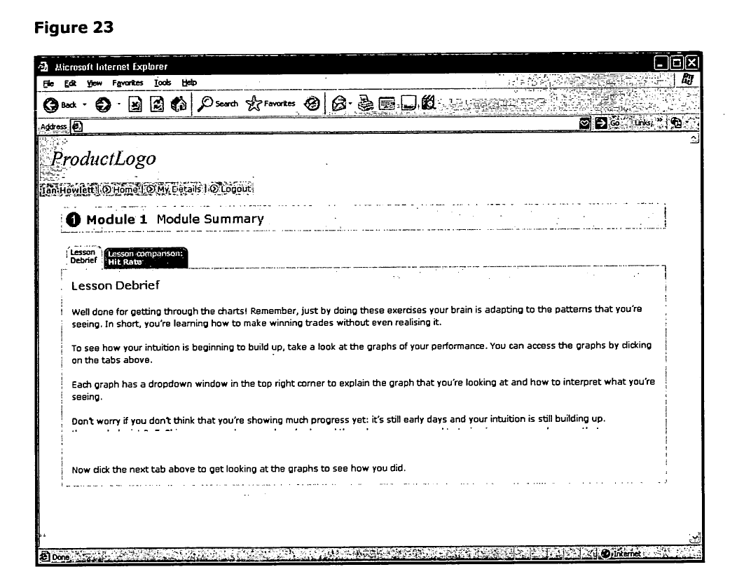

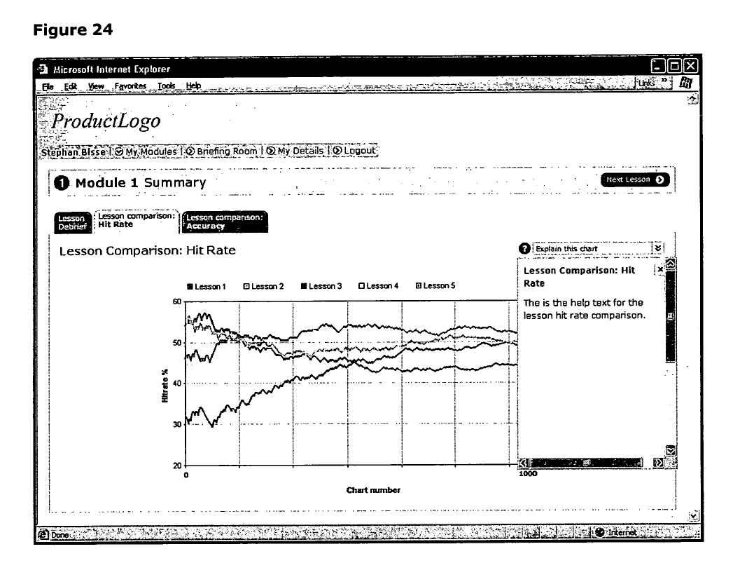

FIG. 23 shows the standard way of showing module summary information. This gives the trader statistics on his performance, presented as a series of tabs containing text and graphs. The summaries are shown at the end of each lesson, including at the end of lesson 5, which is the end of the module.

The first tab is debrief text, which gives a summary of what the trader has done and which statistics are going to be shown, along with how these can be interpreted. FIG. 24 shows a comparison of all five lessons in module 1, drawn as five lines on the same graph. (Of course, if the trader has completed just for example the first two lessons then only two lines will be shown on the graph.) A dropdown containing explanatory text is also shown.

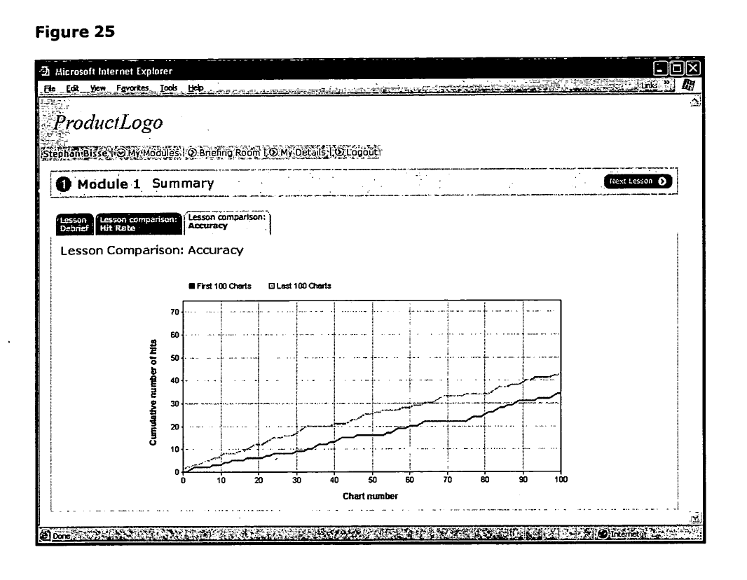

FIG. 25 is specific to Module 1, and shows a comparison of the trader's performance over the first 100 charts in lesson 1 and the last 100 charts in lesson 5, which are the same charts that have been shown again for a second time. It is hoped that the trader will have shown an increased performance between these two attempts.

Module 2 Summaries

The lesson debrief and Lesson Comparison Hit Rate are the same as in Module 1.

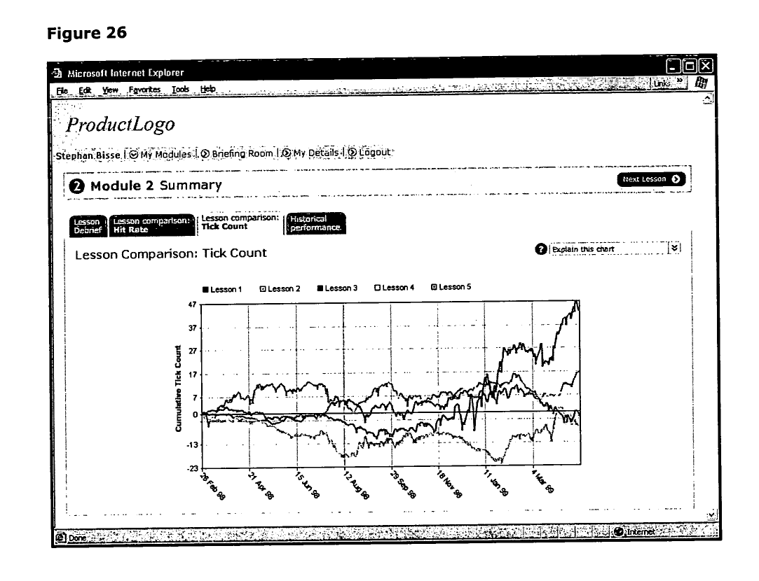

FIG. 26 shows a single graph with a line for the Cumulative Tick Count for each lesson that has been completed in Module 2.

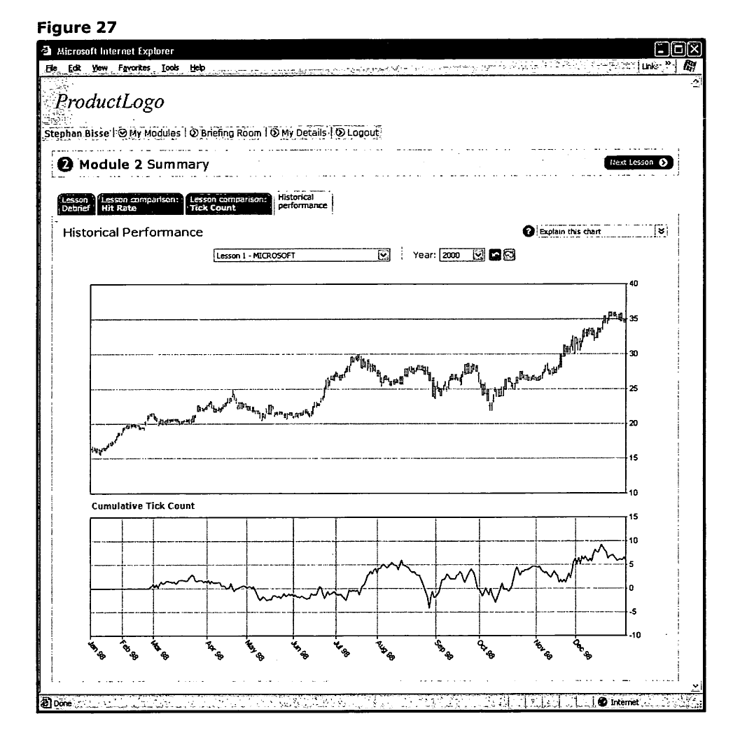

FIG. 27 shows the Historical Performance for this module. Only one lesson's data is shown at any one time on the graphs, and the graphs cover a time period of one year. Navigation is provided above the graphs. The graphs show a year's worth of daily price data, and underneath the tick count of the trader during this time. This is so that the trader can understand the market conditions under which he is best able to make money.

Module 3 Summaries

The same information is shown as per Module 2, with the following addition:

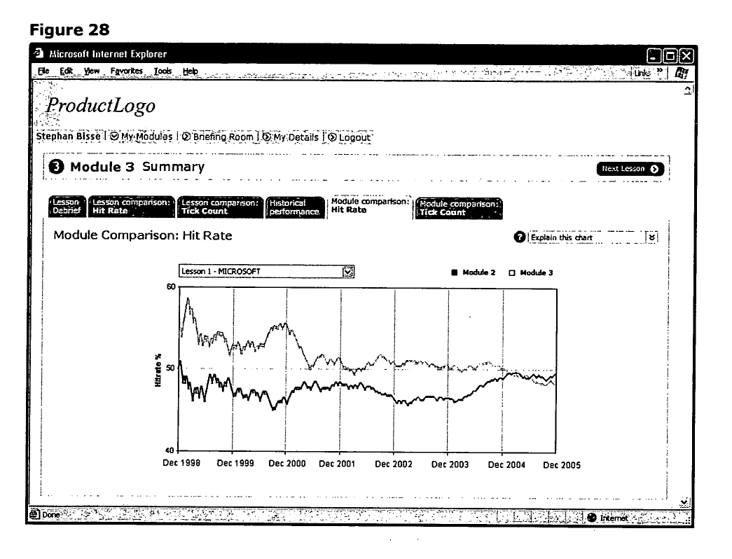

FIG. 28 shows two extra tabs, for Module Comparisons. There are two graphs, one per tab. One compares the hit rate, and the other the tick count, across modules 2 and 3. Each graph covers a single lesson, and the lesson being viewed can be changed from a dropdown box.

Module 4 Summaries

These will include everything in the module 3 summary, but will also include a Lesson Comparison Profit & Loss graph in the same style as the tick count graph.

Module 5 Summaries

These will be the same as the Module 3 summaries (ie no Profit & Loss graph).

### Further Embodiments

This section describes further modules and features that can be used in addition to, or as an alternative to, the previously described modules.

Alternative Chart Types

Modules 1 to 5 use bar charts. Additional modules can teach techniques appropriate to other types of chart, including candlestick charts, line charts, “point and figure” charts and staircase charts. Alternatively, modules 1 to 5 may be adapted for use with other chart types.

Price Spreads

The system can allow for the display of data-series created by the user by subtracting one market's values from another to create what are known as price spreads, or to divide the market values of one market by those of another to create what are known as ratio charts.

Multiple Positions

The trader is able to simultaneously take positions in more than one market and see the combined profit and loss of all of the simulated positions.

News

A module can show news relevant to the market on the day under consideration, since this news may affect how the market moves.

For reference, Table 1 shows a comparison of the 5 specific modules described above according to the present preferred embodiment of the invention.

In this document, reference is made to prices in £ (i.e. GBP; pounds sterling). These could equally well be in $ (i.e. USD; US dollars) or any other currency, for example depending on the home currency of the trader using the system.

TABLE 1

| | | | | | | Tick count in | | |
|---|---|---|---|---|---|---|---|---|
| | | Time | | Chart | | Results for | Profit & | |
| | | Limit Per | | Axis | Technical | last 100 | Loss data | Performance |
| Module | Name | Chart | Markets | labels | Indicators | predictions | shown | comparison |
| 1 | General | 2 min, | Random, | No | No | Not shown | No | Across each |
| | Charts | decreases | non- | | | | | lesson |
| | | | sequential | | | | | |
| 2 | Individual | 2 min, no | 5 in same | Yes | No | Shown | No | Across each |
| | Markets | decrease | category, | | | | | lesson |
| | | | sequential | | | | | |
| 3 | Introduction | 2 min, no | 5 in same | Yes | Yes | Shown | No | Across each |
| | to Technical | decrease | category, | | | | | lesson, and with |
| | Indicators | | sequential | | | | | Module 2 |
| 4 | Position | 2 min, no | 5 in same | Yes | Yes | Shown | Yes | Across each |
| | sizing and | decrease | category, | | | | | lesson, and with |
| | Risk | | sequential | | | | | Modules 2 and 3. |
| | Management | | | | | | | |
| 5 | Inter-Market | 2 min, no | 5 in same | Yes | No | Shown | No | Across each |
| | Relationships | decrease | category, | | | | | lesson, and with |
| | | | sequential | | | | | Modules 2, 3 and |
| | | | | | | | | 4. |

What is claimed is:

1. A market trader training method comprising:
retrieving data representing market price as a function of time;
displaying to a user a visual representation of a portion of the market price data as a function of time;
receiving an input response from the user based on the user's prediction of the subsequent movement of the market price; and
giving an indication to the user of whether the user's input response was in accordance with the actual subsequent movement of the market price known from the retrieved data.

2. The method according to claim 1, wherein the retrieved data corresponds to real market price data.

3. The method according to claim 1, further comprising repeating the receiving and giving steps for successive time intervals of the market price data.

4. The method according to claim 1, further comprising repeating the retrieving, displaying, receiving and giving steps for different markets.

5. The method according to claim 4, wherein the different markets are in the same category.

6. The method according to claim 1, further comprising showing the performance of the user for a plurality of input responses.

7. The method according to claim 6, wherein the performance of the user is shown as a graph or text indicating one or more of:
the cumulative percentage of the user's responses that were in accordance with the actual subsequent movement of the market;
the cumulative result of the user's responses scaled by the magnitude of the actual movement of the market, to give a tick count; and
the cumulative profit or loss of the trades represented by the user's responses.

8. The method according to claim 1, wherein possible input responses by the user comprise one or more of: up, down, pass, go long, go short, go flat, stay long, stay short, stay flat, and a stop order price.

9. The method according to claim 1, wherein the displaying step further comprises providing information relating to at least one technical indicator for the portion of market price data displayed.

10. The method according to claim 1, wherein the displaying step further comprises providing information on at least one market related to the market for which the portion of market price data displayed.

11. The method according to claim 1, wherein the user is given a time limit for inputting a response.

12. The method according to claim 1, wherein the giving step follows the receiving step by less than 1 minute.

13. The method according to claim 1, wherein the giving step follows the receiving step without delay.

14. The method according to claim 1, wherein the indication of whether the user's input response was in accordance with the actual subsequent movement of the market price known from the retrieved data is given to the user substantially instantly following the user inputting the response.

15. A market trader training apparatus comprising:
a retrieving unit for retrieving data representing market price as a function of time;
a display for displaying to a user a visual representation of a portion of the market price data as a function of time;
an input device for the user to input a response based on his prediction of the subsequent movement of the market price; and
a processor for comparing the input response with the actual subsequent movement of the market price known from the retrieved data, and giving an indication to the user of whether the user's input response was in accordance with the actual subsequent movement of the market price known from the retrieved data.

16. A program for causing a computer to carry out a procedure comprising the steps of:
retrieving data representing market price as a function of time;
displaying to a user a visual representation of a portion of the market price data as a function of time;
receiving an input response from the user based on the user's prediction of the subsequent movement of the market price; and
giving an indication to the user of whether the user's input response was in accordance with the actual subsequent movement of the market price known from the retrieved data.
